(19) United States
(12) Patent Application Publication
(10) Pub. No.: US 2014/0164103 A1
(43) Pub. Date: Jun. 12, 2014

(54) SYSTEMS AND METHODS FOR MEASURING ADVERTISING VALUE

(71) Applicant: Andrew Wen, Palo Alto, CA (US)

(72) Inventor: Andrew Wen, Palo Alto, CA (US)

(73) Assignee: CAPITAL ONE FINANCIAL CORPORATION, McLean, VA (US)

(21) Appl. No.: 14/097,443

(22) Filed: Dec. 5, 2013

Related U.S. Application Data
(60) Provisional application No. 61/734,620, filed on Dec. 7, 2012.

(51) Int. Cl. G06Q 30/02

(52) U.S. Cl. CPC G06Q 30/0246
USPC 705/14.45

(57) ABSTRACT

Systems and methods are provided for measuring advertising value based on consumer purchases. A financial service provider creates a baseline purchase rating for sales of a product based on consumer purchases over a first time period. The financial service provider receives advertisement information comprising a frequency of advertisements and a price of advertisements for the product over a second time period. The financial service provider additionally receives consumer purchase transaction information comprising a number of purchases for the product associated with the second time period. An advertisement purchase rating is determined based on the advertisement information and consumer purchase transaction information. The financial service provider may compare the advertisement purchase rating to the baseline purchase rating, and provide a report to participating merchants or to the marketplace at large examining the value of the advertisements based on the comparison.

### CROSS-REFERENCE TO RELATED APPLICATIONS

This application claims priority under 35 U.S.C. §119 to U.S. Provisional Application No. 61/734,620, filed on Dec. 7, 2012, which is expressly incorporated herein by reference in its entirety.

### FIELD

The disclosed embodiments generally relate to analyzing the effectiveness and efficiency of advertising.

### BACKGROUND

The dramatic expansion of digital media platforms since the beginning of the twenty-first century has fostered a parallel expansion in advertising opportunities for retailers. Whereas advertisers in a previous era may have only had to focus on a few television networks, billboards, local radio stations, and selected magazines, the advent of cable television, the Internet, and mobile technologies provides modern advertisers with millions more avenues for product placement. Consequently, retailers now have difficult decisions to make when allocating their advertising budgets.

A retailer can examine their sales figures for an advertised product over a given period of time as a crude calculation of advertising campaign effectiveness, but such a comparison provides little information and no suggestion of how to improve an advertising campaign or to increase sales. Additional information on the cost effectiveness of advertising campaigns, particularly among selected groups of consumers, would provide value to both retailers and advertisers.

Accordingly, there is a need to provide more relevant and comprehensive data to advertisers and retailers related to the value of advertising.

### SUMMARY

Methods, systems, and articles of manufacture described herein enable a computer system to measure advertising value based on consumer purchases. In one embodiment, a computing system may determine a baseline purchase rating for sales of a product based on consumer purchases over a first time period. The computing system may further receive advertisement information, the advertisement information comprising at least a frequency of advertisements and a price of advertisements for the product over a second time period. Also, the computing system may receive consumer purchase transaction information, the consumer purchase transaction information comprising at least a number of purchases of the product during the second time period. The computing system may additionally determine an advertisement purchase rating based on the advertisement information and consumer purchase transaction information. Further, the computing system may compare the advertisement purchase rating to the baseline purchase rating and provide a report based on the comparison to an external system.

In another embodiment, a computer-implemented method is provided for measuring advertising value based on consumer purchases. The method may comprise determining, via one or more processors, a baseline purchase rating for sales of a product based on consumer purchases over a first time period. The method may further include receiving advertisement information, the advertisement information comprising at least a frequency of advertisements and a price of advertisements for the product over a second time period. Also, the method may comprise receiving consumer purchase transaction information comprising at least a number of purchases of the product during the second time period. The method may additionally include determining, via the one or more processors, an advertisement purchase rating based on the advertisement information and consumer purchase transaction information. Further, the method may include comparing, via the one or more processors, the advertisement purchase rating to the baseline purchase rating and providing a report based on the comparison to an external system.

In yet another embodiment, a computing system is disclosed for determining advertising value based on consumer purchases. The computing system may generate at least one advertisement for a product over a first time period. The computing system may further determine first advertisement information comprising at least a frequency of advertisements and a price of advertisements for the product over the first time period. Also, the computing system may generate at least one advertisement for the product over a second time period. The computing system may additionally determine second advertisement information comprising at least a frequency of advertisements and a price of advertisements for the product over the second time period. Further, the computing system may provide the first advertisement information and second advertisement information to a server and receive a report associated with the advertisements from the server.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 illustrates an exemplary system for measuring advertising value consistent with disclosed embodiments.

FIG. 2 illustrates an exemplary system for measuring advertising value consistent with disclosed embodiments.

FIG. 3 depicts a flowchart of an exemplary method for measuring advertising value consistent with disclosed embodiments.

FIG. 4 depicts a flowchart of an exemplary method for creating a baseline purchase rating for a product consistent with disclosed embodiments.

FIG. 5 depicts a flowchart of an exemplary method for receiving advertisement information consistent with disclosed embodiments.

FIG. 6 depicts a flowchart of an exemplary method for receiving consumer purchase transaction information consistent with disclosed embodiments.

FIG. 7 depicts a flowchart of an exemplary method for correlating consumer purchase transaction with the product consistent with disclosed embodiments.

FIG. 8 depicts a flowchart of an exemplary method for comparing the consumer information with the advertisement information consistent with disclosed embodiments.

FIG. 9 depicts a flowchart of an exemplary method for building a report based on the comparison consistent with disclosed embodiments.

FIG. 10 depicts exemplary time periods associated with measuring advertising value, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

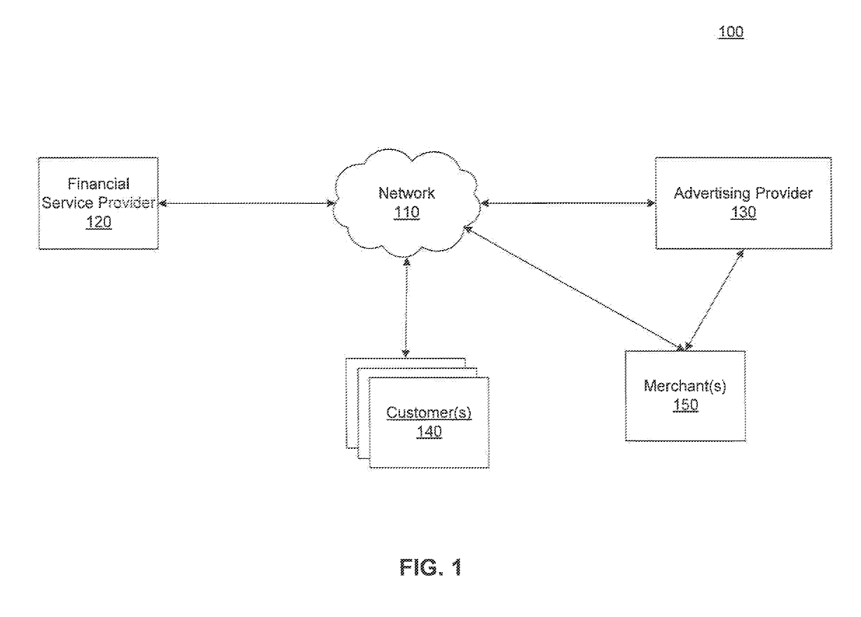

FIG. 1 is a diagram illustrating an exemplary system 100 for measuring advertising value. The components and arrangement of the components described in FIG. 1 may vary. System 100 may include a network 110, financial service provider system 120, advertising provider system 130, customer(s) 140, and merchant system(s) 150.

Network 110 may be any type of network configured to provide communications between components of FIG. 1. For example, network 110 may be any type of network (including infrastructure) that provides communications, exchanges information, and/or facilitates the exchange of information, such as the Internet, a Local Area Network, or other suitable connection(s) that enables system 100 to send and receive information between the components of system 100.

Financial service provider system 120 may be a system that is associated with a financial service provider that provides and manages financial service accounts, such as a bank, credit card company, etc. In one embodiment, financial service provider system 120 may include one or more computing systems that are located at a central location or may include computing devices that are distributed (locally or remotely). In one example, financial service provider system 120 may include a server that is configured to execute software instructions stored in one or more memory devices to perform one or more operations consistent with the disclosed embodiments.

Financial service provider system 120 may provide different financial service products for customers. In one aspect, the financial service provider may provide and manage credit card accounts. In certain aspects, each credit card account may be associated with a customer's financial service account managed by financial service provider system 120. Financial service accounts may include, for example, credit card accounts, checking accounts, savings accounts, loans, or investment accounts. Financial service provider system 120 may execute instructions that monitor customer purchasing transactions associated with financial service accounts, such as credit card accounts.

Advertising provider system 130 may include one or more systems associated with one or more merchant systems 150. In some embodiments, advertising provider system 130 may receive advertisement information from merchant system 150 and convert the information into readable formats. Such information may include the frequency in which merchant system 150 advertises its products/services within a predetermined time period, the amount of money merchant system 150 spends on advertisements within this time period, and the for a through which merchant system 50 distributes its advertisements (e.g. radio, television, mail, etc.). Alternatively, advertising provider system 130 may receive the information from other entities not associated with merchant system 150.

Customer 140 may include one or more consumers and may include consumers in a specific country, state, or geographical region. Alternatively or additionally, customer 140 may include one or more customers with similar demographics. For instance, demographic information may be collected from a variety of sources and include particular social, economic, educational, and/or commercial interests.

Merchant system(s) 150 may include one or more entities that sell products and/or services to customers 140. For example, merchant system 150 may include a physical location (brick and mortar location) and/or may sell the products/services using known e-commerce mechanisms, such as over the Internet via network 110. For instance, merchant system 150 may include department stores, retail shops, grocery stores, pharmacy stores, and specialty stores. Additionally, merchant system 150 may include one or more processors and one or more memories containing software instructions that provide and manage one or more websites or mobile applications that sell products and/or services. In some embodiments, merchant system 150 may include multiple entities within the same industry, that sell competing and/or similar products. For example, merchant system 150 may include 10,000 athletic stores that all sell running shoes.

Merchant system 150 may distribute advertisements associated with the merchant's products and/or services to consumers. For example, merchant system 150 may distribute advertisements through various devices, including but not limited to radio, television, mail, magazines, newspapers, or billboards. Alternatively or additionally, consumers may receive the advertisements through a mobile application, email, text, pop-up alert, and/or by accessing a website displaying the advertisement.

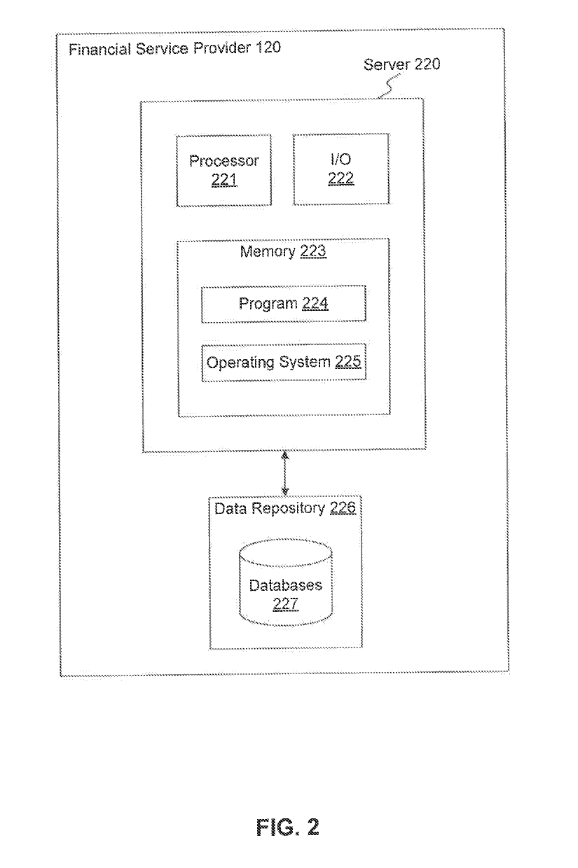

FIG. 2 shows an exemplary system that may be associated with a financial service provider and included in financial service provider 120. In one embodiment, the system includes a server 220 having one or more processors 221, one or more memories 223, and one or more input/output (I/O) devices 222. Alternatively, server 220 may take the form of a general purpose computer, a mainframe computer, or any combination of these components. Server 220 may be stand-alone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems.

Memory 223 may include one or more storage devices configured to store instructions used by processor 221 to perform functions related to disclosed embodiments. For example, memory 223 may be configured with program 224 that performs several functions when executed by processor 221. Therefore, the disclosed embodiments are not limited to separate programs or computers configured to perform dedicated tasks. For example, memory 223 may include a single program 224 that performs the functions of the server 220, or program 224 could comprise multiple programs. Additionally, processor 221 may execute one or more programs located remotely from server 220. For example, financial service provider system 120 may access one or more remote programs that, when executed, perform functions related to disclosed embodiments.

Memory 223 may also be configured with operating system 225 that performs several functions well known in the art when executed by server 220. By way of example, the operating system may be Microsoft Windows™, Unix™, Linux™, Solaris™, or some other operating system. The choice of operating system, and even the use of an operating system, is not critical to any disclosed embodiment.

I/O devices 222 may be one or more device that are configured to allow data to be received and/or transmitted by server 220. I/O devices 222 may include one or more digital and/or analog communication devices that allow server 220 to communicate with other machines and devices, such as customer devices 140.

Server 220 may also be communicatively connected to one or more data repositories 226 as shown in FIG. 2. Server 220 may be communicatively connected to data repository 226 through network 110. Data repository 226 may include one or more files or databases 227 that store information and are accessed and/or managed through server 220. By way of example, databases 227 may be Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, financial service provider system 120 may include data repository 226. Alternatively, data repository 226 may be located remotely from financial service provider system 120, and may be accessible over network 110.

In some aspects, the disclosed embodiments may measure advertising value and, specifically, may measure advertising value across an industry. For example, disclosed embodiments may associate sales figures for one or more products with one or more advertising campaigns for the products. Although a merchant (such as that associated with merchant system 150) may detect how its own sales are affected by its advertisements in particular situations (e.g., for particular geographic regions or advertising deployment methods), the merchant may not have adequate information to gauge the potential success of new advertising campaigns. In some embodiments, merchants may gain insight on whether competitors' advertisements are producing increased product sales for those competitors. For example, disclosed embodiments may be used to determine whether the quantity of sales transactions for a product increased in response to a competitor's advertising campaign.

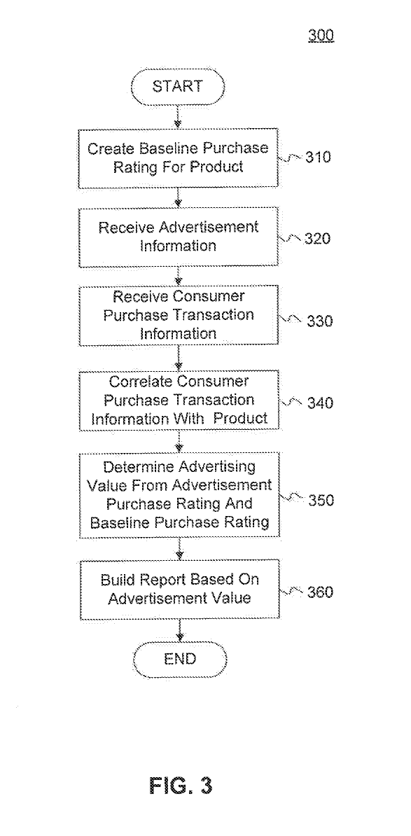

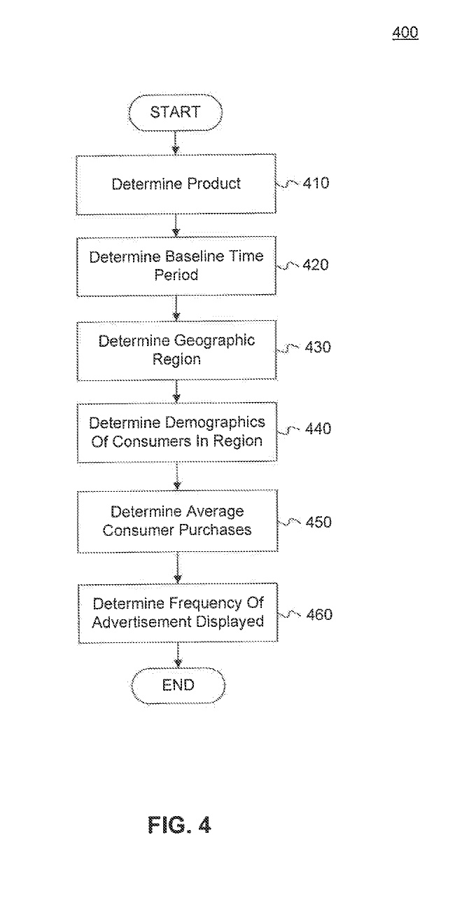

FIG. 3 is a flow diagram 300 of an exemplary method for measuring advertising value, consistent with disclosed embodiments. In step 310, financial service provider 120 may create an industry baseline purchase rating for a product. The baseline purchase rating may reflect an industry standard for a product. Comparisons with the baseline purchase rating may determine if sales increased or decreased within a specific time period. A more detailed discussion is provided below (with respect to FIG. 4) regarding the creation of an industry baseline.

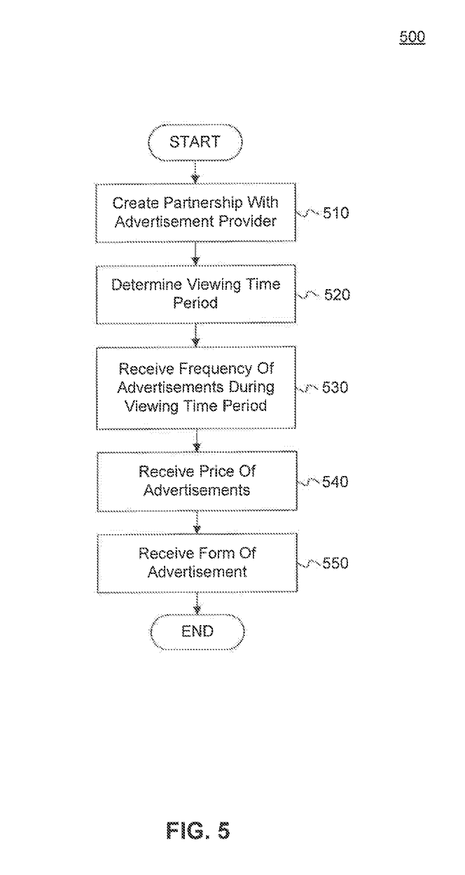

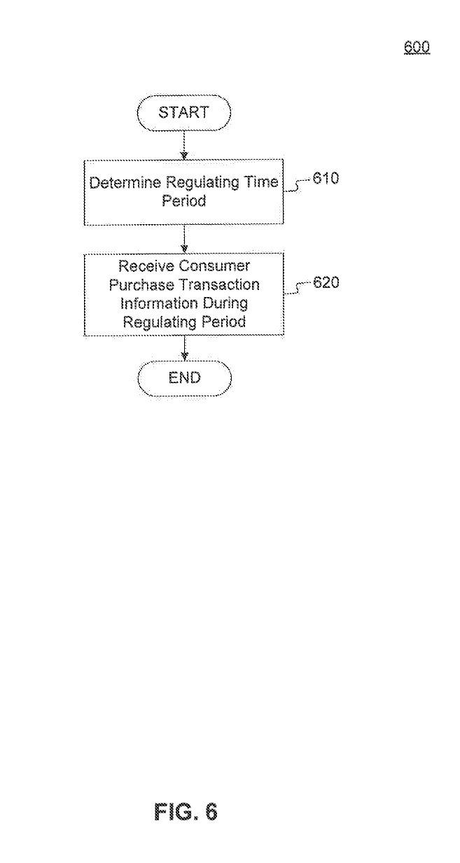

Server 220 may also receive advertisement information (step 320) from advertising provider system 130, as well as consumer purchase transaction information from financial service provider system 120 (step 330). As a non-limiting example, the advertisement information may include information relating to the frequency of advertisements, price of advertisements, and how the advertisements are to be distributed for a specific product within a predetermined time period. The consumer purchase transaction information may include, for example, financial service transaction data for customers associated with financial service provider system 120. For example, consumer purchase transaction data may include financial account identification data, product identification data, timestamp data, merchant identifier data, amount of purchase data, and the like. The consumer purchase transaction information may have occurred within a predetermined time period. Data repository 226 may include consumer purchase transaction information relating to customers of financial service provider system 120. For example, the consumer purchase transaction information may include all transactions performed by each customer of financial service provider system 120 for each financial service product provided to those customers. The financial service transaction information may be configured in database 227 such that it is searchable and may be filtered by server 220. A more detailed discussion is provided below (with respect to FIGS. 5 and 6) regarding the receiving of advertisement information and the receiving of consumer purchase transaction information, respectively.

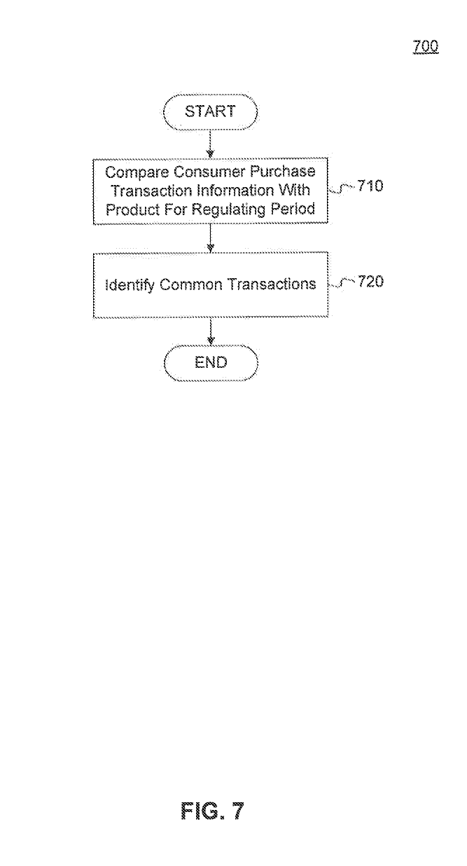

In one aspect, server 220 may correlate the consumer purchase transaction information with a product to determine a number of transactions associated with the product (step 340). Transactions may be associated with a product when the consumer purchase transaction information and product share common identifiers. The transactions associated with the product may reflect the frequency of purchases of the product, by customers associated with financial service provider 120, within a predetermined time period. A more detailed discussion is provided below (with respect to FIG. 7) regarding the correlation of consumer purchase transaction information with the product.

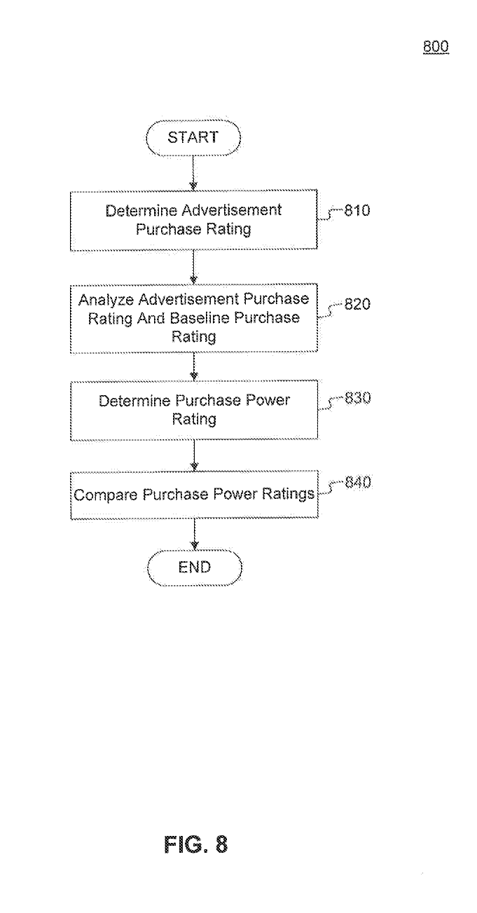

Server 220, in step 350, may further determine the advertisement value for the product. Specifically, server 220 determine a purchase power rating from the advertisement information and customer purchase transaction information. The purchase power rating may indicate the advertisement value for the product. A more detailed discussion is provided below (with respect to FIG. 8) regarding the creation of an advertisement value.

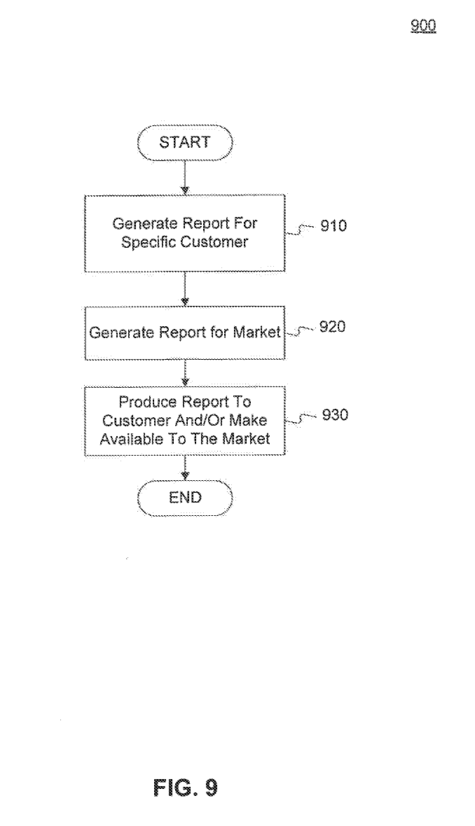

Server 220 may additionally build one or more report(s) based on the advertisement value (step 360). The report may be customer-specific or may apply to an entire market. Server 220 may produce the report to either the customer or make it available to the market. A more detailed discussion is provided below (with respect to FIG. 9) regarding the production of the report.

FIG. 4 shows an exemplary process for creating an industry baseline purchase rating for a product. The industry baseline purchase rating may depict, for example, the value of advertisements in terms of generating customer purchases. In some embodiments, server 220 may generate the industry baseline purchase rating, and the industry purchase rating may represent an industry baseline for the product. In other embodiments, merchant system 150 or advertising provider system 130 may generate the industry baseline purchase rating. Server 220 may generate the industry baseline product by, for example, determining the amount of the product sold within a predetermined time period, the number of customers who purchased the product, and the profits earned from the product

Server 220 may determine one or more products to monitor (step 410). Alternatively, advertising provider system 130 or another entity may determine the product(s) to monitor. The product may include goods and/or services and may be sold by merchant system 150 or other entity. The product may additionally include a specific trade or business that sells several goods and/or services, for example department stores, grocery stores, gas stores, vacation resorts, cruise lines, etc.

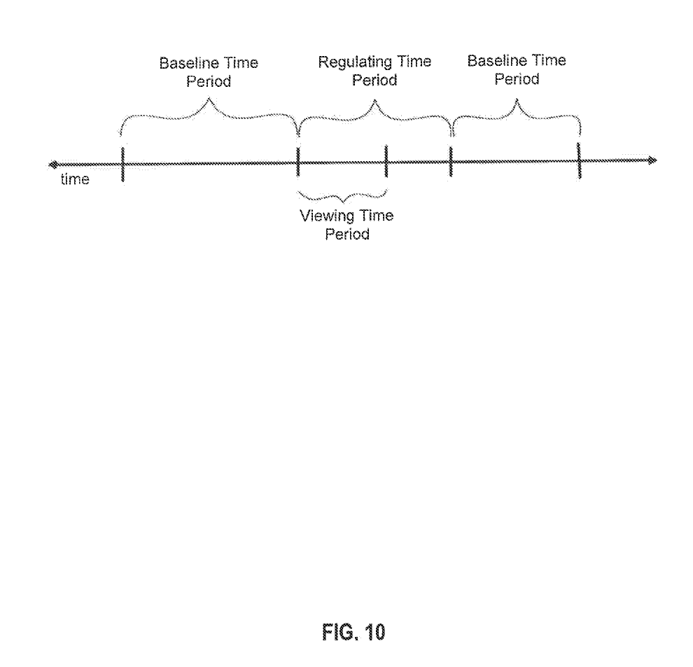

Server 220, merchant system 150, advertising provider system 130, or another entity may provide a baseline time period to determine the baseline purchase rating (step 420, see also FIG. 10). Therefore, the server 220 may monitor the determined product(s) only within the baseline time period to calculate the baseline purchase rating. Server 220, in an exemplary embodiment, may provide a baseline time period of 6 months, 1 year, or 5 years. In another embodiment, the baseline time period may include multiple segments separated in time. The baseline time period may also, for example, be associated with one or more advertising campaigns run by merchant system 150, advertising provider system 130, or another entity.

Server 220 may provide a geographic region to limit the baseline purchase rating (step 430). Therefore, the product may be monitored only within this geographic region. For example, the geographic region may include a predetermined county, town, state, country, or any other geographic segment. In one exemplary embodiment, the geographic region may include the United States and all European countries. In a second exemplary embodiment, the geographic may include only south-eastern states of the United States. Alternatively, server 220 may provide a geographic region covering the entire world. In other embodiments, merchant system 150, advertising provider system 130, or another entity may determine and provide the geographic region to server 220.

Server 220 may limit the baseline purchase rating to include only customers residing within the geographic region. In other embodiments, server 220 may include only purchase transactions of the product that occur within the geographic region and/or merchants that have their principal place of business in the geographic region

Server 220 may alternatively (or additionally) limit the baseline purchase rating to customer demographic information (step 440). In one aspect, the demographic information may include particular social, economic, educational, and/or commercial interests. For example, server 220 may determine the baseline purchase rating based only on, for example, customers that buy football season tickets, have children under the age of 18, are retired, have completed an undergraduate degree, etc. Server 220 may determine which information to consider in determining the baseline purchase rating with, or alternatively, merchant system 150, advertising provider system 130, or another entity may determine such information.

Server 220 may also determine the baseline purchase rating based on the average consumer purchases for the product during the baseline time period (step 450). Specifically, server 220 may divide the total number of product purchases, within the baseline time period and meeting the geographic requirement, by a number associated with time units for the relevant time period (i.e., years, months, days, etc.). In one embodiment, 1 million products were purchased by customers meeting the geographic requirement within a baseline time period of 5 years. If the desired time unit is years, the baseline purchase rating may equal 200,000 purchases per year. If the desired time unit includes months, the baseline time period may equal about 16,666 purchases per month.

In other embodiments, server 220 may compute various statistical data to determine the baseline purchase rating. For example, the baseline purchase rating may include the total number of purchases within the baseline time period, the percentage of purchases compared to the total number of customers within the geographic region, and/or the profits received from sales of the product within the baseline time period.

In other aspects, the baseline purchase rating may include the average consumer purchases involving customers meeting the geographic region and demographic requirements. Therefore, server 220 may divide the total number of purchases of the product by customers meeting the geographic and demographic requirements by the appropriate number of time units. Alternatively, merchant system 150, advertising provider system 130, or another entity may perform this calculation.

In step 460, server 220 may determine the frequency of advertisements displayed during the baseline time period. The advertisements displayed may include advertisements directed toward the product and/or similar competing products.

As shown in FIG. 5, financial service provider system 120 and advertising provider system 130 may establish a partnership. For example, the two entities may agree to communicate regarding advertisements endorsing the product and/or similar competing products. In one exemplary embodiment, server 220 may receive advertising information from advertising provider system 130. The advertisements may originate from merchant system 150, wherein merchant system 150 may include all merchants in the industry or only a predetermined number of merchants. Therefore, the advertisement information may include information for direct competitors in the same industry.

Server 220, merchant system 150, or advertising provider system 130 may determine a viewing time period (step 520). The advertisement information may only include information for advertisements displayed during the viewing time period. Therefore, server 220 may receive advertisement information associated with advertisements displayed during this time period. The viewing time period may be distinguished with the baseline time period such that the two periods do not overlap (see, e.g., FIG. 10). Additionally, the baseline time period may occur before and/or after the viewing time period.

The advertisement information may include such information as frequency of advertisements displayed by competitors selling competing products, the price each competitor pays for the advertisements, and how the advertisements are distributed. For example, the advertisements may be displayed to consumers in various forms, for example, through radio, television, mail, magazine, newspaper, billboards, mobile app, email, text, pop-up alert, and/or by accessing a website displaying the advertisement. Either server 220 or advertising provider system 130 may arrange the advertisement information in various ways, including but not limited to correlating the price and frequency for each form of advertisement.

Turning to FIG. 6, server 220 may additionally receive consumer purchase transaction information from customers meeting the geographic limitation and associated with financial service provider system 120. For example, server 220 may store and maintain consumer purchase transaction information when customers (such as customer(s) 140) make purchases with financial service provider accounts associated with financial service provider system 120. The consumer purchase transaction information may include information relating to each purchase and return used by the account, such as credit cards.

In step 610, server 220 may determine a regulating time period in which to receive the customer purchase transaction information. The regulating time period may overlap with the viewing time period (e.g. FIG. 10). In one exemplary embodiment, the regulating time period begins at substantially the same time as the viewing time period, but the regulating time period extends for a predetermined amount of time after the viewing time period has ended (FIG. 10). Therefore, server 220 may monitor the influence of advertisements during the period when the advertisements are displayed and their prolonged effect. Additionally, the viewing time may be distinguished from the baseline time period such that the two do not overlap. Furthermore, the baseline time period may occur before and/or after the viewing time period.

The consumer purchase transaction information may identify, for example, the products purchased in each transaction and customer information. In one exemplary embodiment, the customer purchase transaction information may include financial account identification data, product identification data, timestamp data, merchant identifier data, authorization codes, and amount of purchase data. As shown in FIG. 7, for each customer associated with financial service provider system 120, server 220 may compare this information with product SKU information (step 710). Server 220 may then identify the common transactions representing when customers associated with financial service provider system 120 purchased the product (step 720).

As shown in FIG. 8, server 220 may determine an advertisement value from the frequency of common transactions. Specifically, server 220 may divide the number of common transactions with the appropriate number of time units to generate an advertisement purchase rating. For example, if 500,000 common transactions occurred during a regulating time period of one year, and the desired time unit is years, the advertisement purchase rating would equal 500,000 purchases per year. If the desired time unit is months, the advertisement purchase rating would equal about 41,667 purchases per month.

In other exemplary embodiments, server 220 may compute various statistical data to determine the advertisement purchase rating. For example, the advertisement purchase rating may include the total number of common transactions within the regulating time period, the percentage of common transactions compared to the total number of customers within the geographic region, and/or the profits received from sales of the product within the regulating time period.

In other aspects, the advertisement purchase rating may include the average consumer purchases, within the regulating time period, involving customers meeting the geographic region and demographic requirements. Therefore, server 220 may divide the number of common transactions, from customers meeting the geographic and demographic requirements, by the appropriate number of time units. Alternatively, merchant system 150, advertising provider system 30, or another entity may perform this calculation.

Server 220 may analyze the advertisement purchase rating and the baseline purchase rating to determine if more products were purchased as a result of the advertisements. Specifically, a higher advertisement purchase rating than a baseline purchase would indicate more products were sold as a result of the advertisements.

Server 220 may additionally determine a purchase power rating (step 830). Server 220 may determine the purchase power rating based on a comparison of the advertisement purchase rating with the baseline purchase rating, as well as a comparison of the frequency of advertisements during the viewing time period with the frequency of advertisements during the baseline time period. The purchase power rating may represent, for example, the advertising value. For example, if the advertisement purchase rating and frequency of advertisements during the viewing time period increased compared with the baseline purchase rating and frequency of advertisements during the baseline time period, server 220 may award a higher purchase power rating. On the other hand, if the advertisement purchase rating remained similar to the baseline purchase rating while the frequency of advertisements during the viewing time period increased compared with the frequency of advertisements during the baseline time period, server 220 may award a lower purchase power rating. Server 220 may compare the purchase power ratings of the various forms of advertisements and/or the purchase power ratings of different competitors.

As shown in FIG. 9, server 220 may generate a report based on these determinations. The report may be tailored for a specific merchant (e.g., specific competitors requested by the merchant) (step 910) and/or may focus on the entire industry (e.g. include all competitors) (step 920). Server 220 may organize the report to compare the value of advertisements associated with frequency of advertisements, price of advertisements, and form of advertisements displayed. Furthermore, server 220 may produce the report to the specific merchant and/or make the report available to the market (step 930).

FIG. 10 depicts exemplary time periods associated with measuring advertising value, consistent with disclosed embodiments. A baseline time period may represent, for example, a time period where customer purchase transactions are not considered associated with an advertising campaign. The regulating time period may represent, for example, the time period in which customer purchase transaction information may be attributed or otherwise associated with an advertising campaign. Finally, the viewing time period may represent, for example, the time period in which an advertising campaign was active.

Other embodiments will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for measuring advertising value based on consumer purchases, comprising:
a memory storing instructions; and
a processor configured to execute the instructions to:
determine a baseline purchase rating for sales of a product based on consumer purchases over a first time period;
receive advertisement information, the advertisement information comprising at least a frequency of advertisements and a price of advertisements for the product over a second time period;
receive consumer purchase transaction information, the consumer purchase transaction information comprising at least a number of purchases of the product during the second time period;
determine an advertisement purchase rating based on the advertisement information and consumer purchase transaction information;
compare the advertisement purchase rating to the baseline purchase rating; and
provide a report based on the comparison to an external system.

2. The system of claim 1, wherein the processor is further configured to execute the instructions to:
compare a frequency of advertisements for the product during the first time period to the frequency of advertisements during the second time period; and
determine a purchasing power rating based on the comparison, the advertisement purchase rating, and the baseline purchase rating.

3. The system of claim 2, wherein the provided report further comprises the purchasing power rating.

4. The system of claim 1, wherein the processor is further configured to execute the instructions to:
determine one or more of the number of purchases of the product sold during the first time period, a number of individual consumers who purchased the product during the first time period, or profits earned from sales of the product during the first time period.

5. The system of claim 1, wherein at least one of the baseline purchase rating or the advertisement purchase rating is determined for all products of a particular merchant.

6. The system of claim 1, wherein the baseline purchase rating and the advertisement purchase rating are determined based on consumer purchases within a particular geographical location.

7. The system of claim 1, wherein the baseline purchase rating and the advertisement purchase rating are determined based on purchases by one or more subsets of consumer demographic groups.

8. The system of claim 7, wherein the consumer demographic groups comprise one or more of employment status, annual income, age, level of education attained, number of children, or age of children.

9. The system of claim 1, wherein the received advertisement information further comprises at least a frequency of advertisements and a price of advertisements for at least one competing product over the second time period.

10. A computer-implemented method for measuring advertising value based on consumer purchases, comprising:
determining, via one or more processors, a baseline purchase rating for sales of a product based on consumer purchases over a first time period;
receiving advertisement information, the advertisement information comprising at least a frequency of advertisements and a price of advertisements for the product over a second time period;
receiving consumer purchase transaction information, the consumer purchase transaction information comprising at least a number of purchases of the product during the second time period;
determining, via the one or more processors, an advertisement purchase rating based on the advertisement information and consumer purchase transaction information;
comparing, via the one or more processors, the advertisement purchase rating to the baseline purchase rating; and
providing a report based on the comparison to an external system.

11. The method of claim 10, further comprising:
comparing the frequency of advertisements for the product during the first time period to the frequency of advertisements during the second time period; and
determining a purchasing power rating based on the comparison, the advertisement purchase rating, and the baseline purchase rating.

12. The method of claim 11, wherein the provided report further comprises the purchasing power rating.

13. The method of claim 10, wherein determining the baseline purchase rating further comprises one or more of determining the amount of the product sold during the first time period, the number of individual consumers who purchased the product during the first time period, or the profits earned from sales of the product during the first time period.

14. The method of claim 10, wherein one or more of the baseline purchase rating or the advertisement purchase rating is determined for all products of a particular merchant.

15. The method of claim 10, wherein the baseline purchase rating and the advertisement purchase rating are determined based on consumer purchases within a particular geographical location.

16. The method of claim 10, wherein the baseline purchase rating and the advertisement purchase rating are determined based on purchases by certain demographic subsets of consumers.

17. The method of claim 16, wherein the consumers are separated into the demographic subsets based on one or more of employment status, annual income, age, level of education attained, number of children, or age of children.

18. The method of claim 10, wherein the received advertisement information further comprises at least the frequency and price of advertisements for at least one competing product over the second time period.

19. A system for determining advertising value based on consumer purchases, comprising:
a memory storing instructions; and
a processor configured to execute the instructions to:
generate at least one advertisement for a product over a first time period;
determine first advertisement information comprising at least a frequency of advertisements and a price of advertisements for the product over the first time period;
generate at least one advertisement for the product over a second time period;
determine second advertisement information comprising at least a frequency of advertisements and a price of advertisements for the product over the second time period;
provide the first advertisement information and second advertisement information to a server; and
receive a report associated with the advertisements from the server.

20. The system of claim 19, wherein the received report comprises information associated with one or more of the first advertisement information, the second advertisement information, a number of purchases associated with the product during the first time period, and a number of purchases associated with the product during the second time period.
